(19) United States
(12) Patent Application Publication
(10) Pub. No.: US 2008/0198473 A1
(43) Pub. Date: Aug. 21, 2008

(54) Variable Focus Lens

(75) Inventors: Jaap Ruigrok, Eindhoven (NL); Helmar Van Santen, Amsterdam (NL); Michael Adrianus Henricus Van Der Aa, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/917,171

(22) PCT Filed: Jun. 12, 2006
(86) PCT No.: PCT/IB06/51864

§ 371 Date: Dec. 11, 2007

(30) Foreign Application Priority Data
Jun. 16, 2005 (EP) 05105286.8

(51) Int. Cl. G02B 3/14

(52) U.S. Cl. 359/666

(57) ABSTRACT

The invention relates to variable focus lenses based on magneto wetting and related devices, wherein two fluids, one of which is magnetically susceptible, are in contact over a meniscus. The shape of the meniscus is controlled by means of an applied magnetic field gradient. The contact angle between the chamber wall and the meniscus is a conserved. Implementation of special shaping to the internal or external walls of the chamber, while conserving the contact angle, results in better lens shape in the variable focus lens and lower levels of lens distortion.

### FIELD OF THE INVENTION

The invention relates to variable focus lenses where focus is changed by a manipulation of the shape of a meniscus between two fluids. In particular, the invention relates to magneto wetting lenses, where a change in applied magnetic field initiates a change in meniscus shape. A variable focus lens generally comprises a fluid chamber containing a first fluid and a second fluid, the fluids being immiscible and in contact over a meniscus, and the second fluid being able to alter its shape under the influence of a magnetic field, and also comprises means for applying a gradient magnetic field over at least part of the fluid chamber. The shape of the meniscus comprises a curvature under application of the gradient magnetic field, which is distorted by a physical requirement of a constant contact angle where the meniscus contacts a chamber wall, such that the curvature comprises a first region of high distortion close to the chamber wall and a second region of low distortion away from the chamber wall

### BACKGROUND OF THE INVENTION

Variable focus lenses are known from WO 03/069380, where the mechanism for adjustment of the meniscus is the electro wetting technique. In such a technique, a change in voltage applied to a cell, containing two immiscible liquids in contact over a meniscus, produces a change in contact angle of the liquids with the wall of the cell, which in turn changes the shape of the meniscus interface.

In a variable focus lens based on a magneto-wetting cell, a gradient magnetic field is applied to the cell. One of the liquids present must be able to alter its shape in response to the magnetic field in order to produce a change in curvature of the meniscus. Such a fluid may be a Ferro fluid, for example. A variable focus lens based on magneto wetting is discussed in EP04102437.3 (not yet published at the priority date of this application).

Variable focus lenses are often incorporated into devices where space is at a premium or where cost considerations are important. Such devices include, solid-state lighting devices, optical devices, mobile telephones with photographic capability, image capture devices and optical recording devices.

A disadvantage with known variable focus lenses based on magneto wetting is distortion in the lens, particularly at lens edges, as soon as a magnetic gradient field is applied.

### SUMMARY OF THE INVENTION

It is an object of the invention to provide a variable focus lens based on magneto wetting which has a lower level of distortion.

This object is achieved according to the invention by provision of a variable focus lens based on magneto wetting, characterized in that the curvature is arranged by a compensating wall section such that in the first region of high distortion the curvature approaches an extrapolation of the curvature in the second region of low distortion.

If a Ferro fluid or any fluid which is affected by a gradient magnetic field is exposed to a magnetic field, the fluid experiences a volume force in the direction of increasing magnetic field strength. These forces are strongest close to the current carrying coil producing the magnetic field: in the case of a variable focus lens the strongest forces are likely to be found at the walls of the chamber housing the fluids. In other words, the volumetric force experienced by the fluid is dependent on radial position across the chamber. The magnetic forces allow transport of the fluid but have no effect on the contact angle of the fluids (and therefore the meniscus) with the wall of the chamber. The meniscus tends to change shape such that fluid is moved above or below its starting meniscus, i.e. the new meniscus has a line of crossing with the starting position. In general, the meniscus tends towards a spherical shape in the bulk fluid, deviating from spherical towards the walls of the chamber when a gradient magnetic field is applied.

Summarized, the combination of fluid volumes and contact angle conservation leads to unwanted meniscus edge behavior that reduces the effective lens area when a magnetic gradient field is applied. Distortion is introduced into the lens by irregularities in the meniscus shape, particularly close to the edges of the meniscus.

According to the invention, the walls of the chamber containing the fluids are shaped in the region where the wall may be in contact with the meniscus. The walls are designed in the first approximation by numerical calculation. From the various interface tensions first the contact angle is calculated. Then a first wall shape is calculated from the contact angle constraint, the constraint of constant volumes of both liquids and the assumption of an ideal meniscus shape. The shape of the meniscus can be approximated as spherical for the first calculations. Further calculations taking account of the bulk fluid forces may be performed, or experiments done on a prototype of the first wall shape, to refine the wall shape further, given the actual magnetic field. At the wall, the contact angle remains conserved (physical requirement).

The shape of the wall may be tailored to suit a particular application or device. The wall shape allows the ideal meniscus shape at the edges to be conserved more accurately, and hence the overall shape of the meniscus to be better controlled, with less undesired edge deformation of the meniscus. (The actual contact angle may be chosen as a desired value by careful selection of the fluids and chamber, the contact angle being a conserved property of the system). The curvature of the meniscus interface can therefore be tuned more easily, more gradually, and with a better lens shape than in the case of a straight chamber wall. The lens shape also extends further across the cell as the edge effects are reduced, giving a larger effective lens area. The curvature at zero magnetic field gradient is determined by the orientation of the wall at the locations where the meniscus touches the wall and the contact angle.

For a contact angle of 90 degrees, the above-determined shape of the wall becomes such that the spherical meniscus surface is independent of the meniscus curvature. Hence, for this particular case the total surface energy is independent of its curvature. Consequently in practice, the force, field and energy required to change the curvature will be very low. For stability of the meniscus position it is, however, better to choose the field not too small. Alternatively or in addition, a contact angle deviating (slightly) from 90 degrees or a wall deviating (slightly) from the ideal one can be chosen to obtain sufficient stability.

In a further embodiment of the invention, the wall section is sub-divided into discreet regions of variable local shape superimposed on the shape of the wall section. Instead of a continuous spectrum of possible meniscus positions, a series of steps are positioned at specific intervals along the continuum. Thus the wall of the chamber must be shaped overall in such a way as to allow contact angle to be conserved and meniscus shape advantages to be present, as described above, but with additional shapes being present which coincide with discreet, desired positions of the meniscus. These additional shapes could take many forms, for example wedges, mini-spheres, hemispheres, pyramids, or any other shape capable of forming preferred regions for the meniscus at the wall of the chamber.

It is envisaged that the discreetisation of the wall would allow for pockets of preferred meniscus positions. To move between these stable states extra energy would be required, more than needed to move along a continuum. Thus the discreet positions are protected and stable. Due to the optimized wall shape according to the invention, the meniscus shape is also less prone to edge effects and thus has a better overall shape and larger effective lens area at these discreet positions. Discreet positions can also be advantageous to prevent unnecessary tilting of the meniscus interface. By narrowing the continuum of positions available to the meniscus, the precise position of the meniscus at the wall can be more precisely defined, and therefore more accurately aligned across a chamber (but allowed tolerances become smaller). It is also envisaged to have a situation where the magnetic field is switched on to provide sufficient power to move the meniscus to a discreet position and then, with the meniscus secured in a stable manner, the magnetic field is switched off, thereby trapping the meniscus at the desired curvature and location. This has positive benefits for the power consumption of the device containing the variable focus lens and reduces heating effects in the device.

In a further embodiment of the invention, the second fluid comprises a Ferro fluid. In principle, all fluids having sufficient magnetic moment can be utilized in the invention. Ferro fluids, however, have the further advantage that in a gradient magnetic field the Ferro fluid responds as a homogeneous magnetic liquid, which moves to the region of highest flux density. The Ferro fluid may take the form of a multi-phase liquid wherein magnetic particles are held in colloidal suspension.

A Ferro fluid is usually a stable colloidal suspension of sub-domain magnetic particles in a liquid carrier. The particles, which have an average size of about 10 nm, are coated with a stabilizing dispersing agent (surfactant), which prevents particle agglomeration even when a strong magnetic field gradient is applied to the Ferro fluid. The surfactant must be matched to the carrier type and must overcome the attractive van der Waals and magnetic forces between the particles. The colloid and thermal stabilities, crucial to many applications, are greatly influenced by the choice of the surfactant. A typical Ferro fluid may contain by volume 5% magnetic solid, 10% surfactant and 85% carrier.

In a further embodiment of the invention, the means for applying a gradient magnetic field comprises at least two independent electrically conducting coils. Application of a magnetic field in a variable focus lens is often achieved with a magnetic field produced by a single current carrying coil. In the case of a contact angle of 90 degrees and a cylindrical wall at the flat meniscus contour at zero magnetic field, the use of two independent coils allows the meniscus to be moved through a full range of movement from convex to concave, thereby enhancing device performance. However, the stability of intermediate positions has then to be obtained. For a contact angle strongly deviating from 90 degrees, a single coil suffices.

Alternatively, the means for applying a gradient magnetic field may take the form of shaped soft magnetic material arranged around the chamber in the region of the meniscus position, which is subject to magnetization by a second homogeneous magnetic field.

In a further embodiment of the invention, a solid-state lighting device comprises a variable focus lens as described in its different embodiments above. The general goal of the solid-state lighting device is to direct, and if necessary collimate, the broad spatial distribution of the primary light radiated by a simple light source in the device. In particular it can be used to control the solid angle of a light source as demanded at a certain moment at a certain place. By utilizing a variable focus lens as described in the invention, the solid angle of the light can be controlled as desired, and without any mechanical movement. The shape of the lens is less prone to edge effects and is therefore all less prone to distortions. It is highly suitable for use in combination with the small modern solid-state primary light source LED (light emitting diode). Very small dimensions are possible, in the order of 1 cubic mm. The power requirement is advantageously low. Such devices are suitable for use in diverse areas of application, such as the automotive industry, traffic lights, ambient lighting.

In further embodiments of the invention, the variable focus lens as described in its different embodiments above, may be incorporated into different devices. The basic lens unit is small, operates at low voltages and power, has no moving mechanical parts and is potentially relatively cheap. Such a unit can replace conventional lenses in devices such as, optical devices, image capture devices, or telephones.

### BRIEF DESCRIPTION OF THE DRAWINGS

These and other aspects of the invention will be further described with reference to the drawings, in which:

FIG. 1 is a schematic diagram of a magneto wetting variable focus lens, as known in prior art.

FIG. 2 is an embodiment of the invention for a variable focus lens with a shaped chamber wall section according to the invention.

FIG. 3 is an embodiment of the invention for a solid-state lighting device.

FIG. 4 is an embodiment of the invention for a variable focus lens based on magneto wetting with two independent electrically conducting coils.

FIG. 5 is an embodiment of the invention comprising stepped wall sections superimposed on a shaped wall section according to the invention.

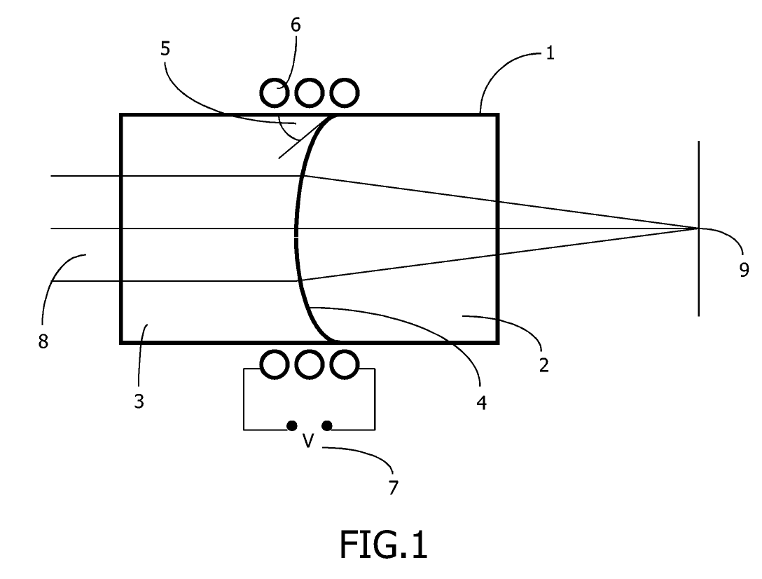

FIG. 1 illustrates a conventional type of variable focus lens based on the principles of magneto wetting. A chamber 1 contains a first fluid 2 and a second fluid 3, which are immiscible, and which are in contact via a meniscus 4. The second fluid 3 has the property that its volumetric shape is modified in the presence of a magnetic field. Such a fluid 3 may be a Ferro fluid. The meniscus 4 is in contact with one or more walls of the chamber 1. A contact angle 5 exists where the chamber walls and the first and second fluids 2 and 3 meet. The value of this contact angle 5 depends on the fluids 2 and 3 chosen, and on the properties of the chamber 1 walls (e.g. whether the walls are coated, or the type of material they are constructed from). The contact angle 5 is thus a property of the system. Around the chamber 1, positioned to surround the location of the meniscus 4 in the chamber 1, is an electrically conducting coil 6. This coil 6 is connected to a voltage supply 7. When electrical current flows in the coil 6, a magnetic field is generated which acts on the fluids 3 in the chamber 1. The second fluid 3 which is susceptible to the magnetic disturbance experiences a volume force allowing fluid transport. The space occupied by the second fluid 3 (and the first fluid 2) changes, consequently altering the curvature of the meniscus 4. As the strength of applied magnetic field is increased, the meniscus curvature change is more pronounced. A light beam 8 passing through the chamber 1 is affected by the change in refractive index between the first and second fluids 2 and 3 and by the curvature of the meniscus 4. In the arrangement shown in the figure, the effect is to converge rays of light towards a focus point 9. The stronger the curvature of the meniscus 4, the more the effect on the light beam 8.

Changes in the magnetic field strength are thus directly related to the focusing power of the variable focus lens. The changes in magnetic field strength are not without other consequences, however. The contact angle 5 is a feature of the system which is conserved no matter where the point of contact between meniscus 4 and chamber 1 walls. As the fluids become more distorted on increasing application of a magnetic field, the meniscus 4 shape deviates more and more from the (chosen) relatively flat starting position. It becomes more difficult to maintain the shape of the meniscus 4 curvatures away from the central region of the chamber 1 towards the point of contact with the wall. Distortion of the meniscus is most pronounced close to the wall. Thus the effective lens area available is reduced and the lens performance is affected. Further, as it becomes more difficult to further change the meniscus 4 curvature, the amount of electrical energy and power required will also increase. This power consumption is limiting and undesirable in a device containing the variable focus lens.

The contact angle can be maintained while avoiding problems with meniscus shape, effective lens area loss, and increased energy and power consumption, by implementation of an embodiment of the invention. The invention is to change the shape of the wall (external or internal) of the chamber 1 at places where the meniscus 4 contacts, either at rest or during the movement of the fluids under magnetic influence. The required shape of the wall can be calculated (estimated) when the system is designed by reference to the characteristics of the first and second fluids 2 and 3 and the wall material or coating resulting in the fixed contact angle, and the size of the chamber 1. The aim is to improve the lens shape across more of the lens area while allowing the meniscus 4 to change curvature.

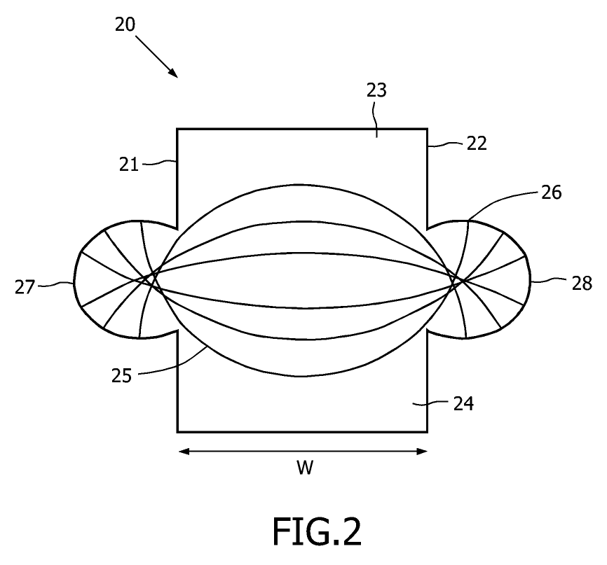

An embodiment of the invention is shown in FIG. 2. A lens chamber 20 is provided with cylindrical walls, shown in the cross-sectional drawing as 21 and 22. First and second fluids 23 and 24 are present in the chamber 20, the second fluid 24 being a Ferro fluid. The first and second fluids 23 and 24 are in contact over a meniscus 25, which is shown in the figure in six possible positions according to the magnetic field applied (by means not shown here). The meniscus 25 contacts the wall with a particular contact angle 26. Cylindrical walls 21 and 22 contain special wall sections 27 and 28, respectively. Wall sections 27 and 28 are formed into a shape which has been determined by numerical calculation, taking account of conservation of contact angle 26, the conservation of volumes of the fluids 23 and 24, and the desired meniscus/lens shape(s).

In this particular figure and embodiment, the contact angle dictated by the fluids and wall (coating) is assumed to be 90 degrees and the meniscus shapes are approximated by hemispheres (3D) and parts of a circle (2D).

All meniscus positions shown in FIG. 2 have improved meniscus shape 25 at the edges due to the wall shape, making it possible to have high meniscus curvatures with less distortion, especially at meniscus edges, and thus larger effect lens areas.

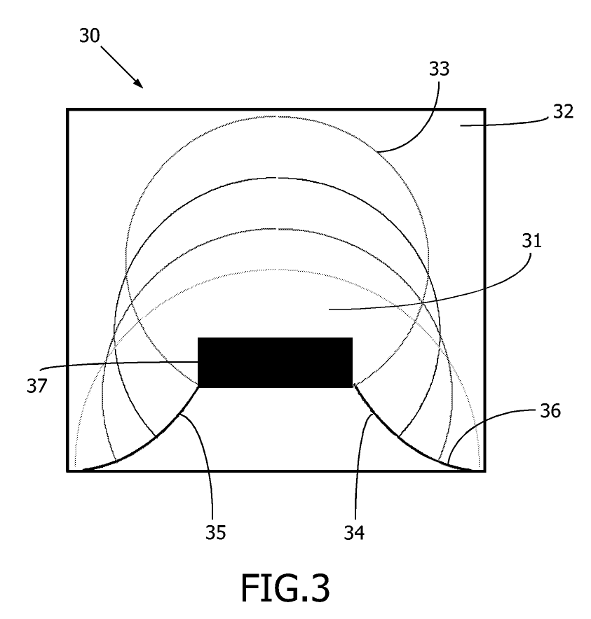

FIG. 3 shows a further embodiment of the invention, in this case related to solid-state lighting devices. In this device chamber 30, first and second fluids 31 and 32 are present and are in contact over a meniscus 33. Four positions of the meniscus 33 are shown in the diagram, but a continuum of positions along an internal wall (shown as sections 34 and 35 in the figure) is possible. The contact angle 36 is physically a conserved quantity in a magneto wetting lens and consequently the same for each meniscus position.

The general goal of the solid-state lighting device is to control, usually to collimate, the broad spatial distribution of the primary light that is radiated by a simple light source 37. For the figure, the primary light source (not shown) is a light emitting diode (LED). For a “white LED”, a small-wavelength (blue) LED is embedded in phosphors which generate all colors to approximate white light. In addition to the LED, the light source 37 may also contain a substrate (not shown) and electronics (not shown). The electronics may also include control circuitry (not shown) for manipulation of the electric current flowing through coils, which are used to generate the magnetic field to drive and position the meniscus 33.

In the figure the contact angle 36 is set at 90 degrees, but this may be chosen to be another angle depending on material characteristics. The edge effects near the lines of contact with the internal wall are reduced by the designed shape of the internal wall thereby giving better overall lens performance. Movement of the meniscus under influence of the magnetic field produces different lens curvatures and therefore different light distributions.

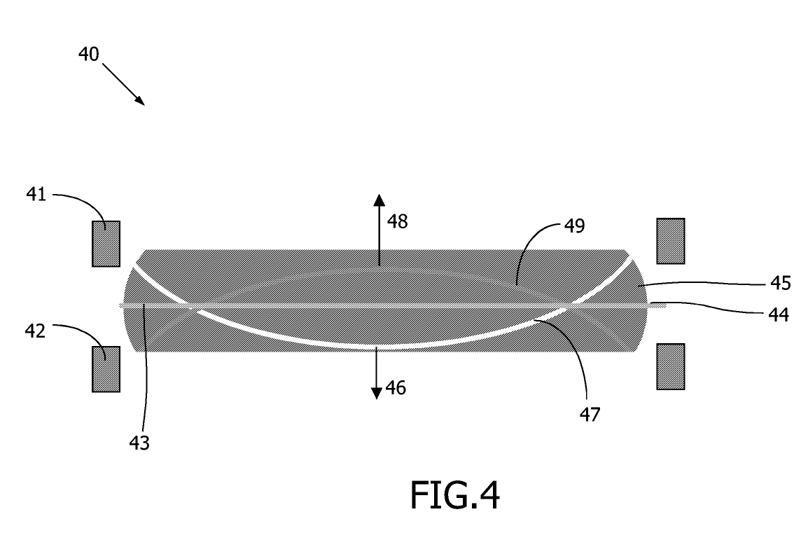

FIG. 4 shows an embodiment of the invention applied to a variable focus lens. A chamber 40 comprises two fluids (here not labeled), one of which is a Ferro fluid, and which are in contact over a meniscus. The chamber 40 also comprises two independent electrically conducting coils 41 and 42. At the starting position considered here, the meniscus 43 between the fluids is in position as shown and is relatively flat while obeying conservation of fluid volumes. Here the contact angle 44 is selected (via choice of fluids and wall or wall-coating materials) such that the contact angle is 90 degrees, while the volumes of the fluids are such that the lower fluid would fill up until the middle line 43 whenever the meniscus would be flat. In addition, the meniscus shapes are all assumed spherical. This should not, however, be considered as limiting for other contact angles and meniscus shapes. In the figure the contact angle 44 is chosen as 90 degrees and the interface meniscus 43 is positioned in the middle of the curved container wall 45, which is shaped according to the invention. When current flows through coil 41, the lower fluid will move upwards (with respect to the starting position) near the wall of the chamber 40, while consequently moving downwards, as indicated by arrow 46, near the center of the chamber 40. When the fluid is in its new position, the meniscus 47 will be curved almost spherical over almost the entire diameter of the chamber 40 as a result of the curvature of the wall 45 and the fixed contact angle 44. The opposite happens when current flows through coil 42, the resulting direction of fluid movement in the center of the chamber 40 being indicated by arrow 48 and the meniscus 49 having a position as shown. The curvature of the wall 45 ensures that the best lens shapes are obtained, and thus with the lowest distortion and loss of effective area. A range of possible lens shapes depend on the current flowing through coils 41 or 42. In this example, the possible lens curvatures depend mainly on coil position and to a lesser extent on coil current. The starting position is not necessarily stable in the absence of any coil current because in the example all meniscus curvatures have the same or almost the same total energy in the absence of a gradient magnetic field.

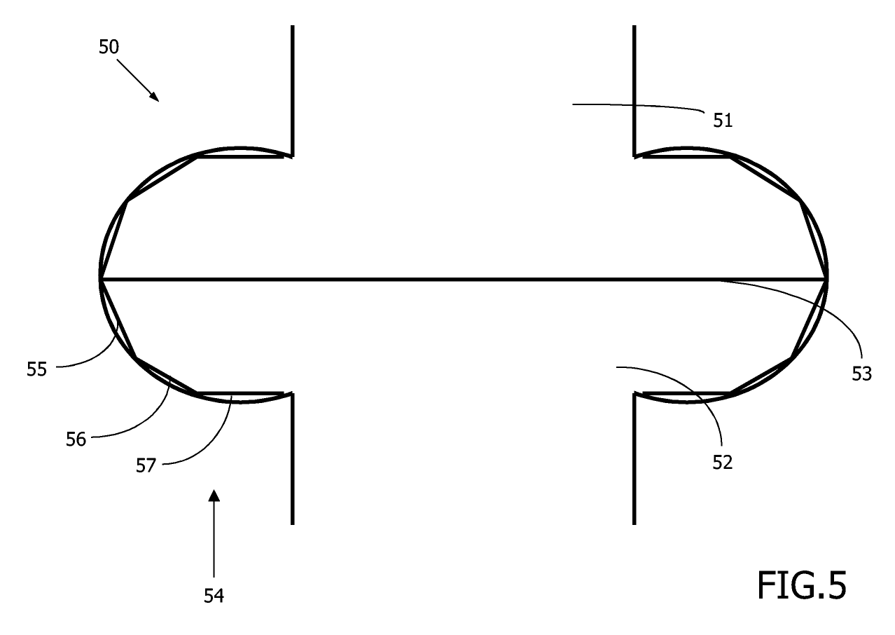

FIG. 5 illustrates a refinement of the invention wherein a wall section of a lens chamber 50, already specially shaped, and is further designed to include a series of wall section steps. The chamber 50 forms a variable focus lens, having first and second fluids 51 and 52 present, the second fluid 52 being a Ferro fluid and being influenced by means for applying a magnetic field to the chamber 50 (not shown), the first and second fluids 51 and 52 being in contact over a meniscus 53. The meniscus 53 is shown here arranged in an equilibrium position. As previously described, a change in meniscus 53 position can be effected by a change in gradient magnetic field applied to the chamber 50. In FIG. 2 a similar situation is shown where the meniscus is free to move over a continuous wall section 27, an equivalent wall section 54 being present in chamber 50. This has advantages, as lower energy is required to move the meniscus 53 in order to effect lens action. With such a wide range of possible meniscus positions, however, it can be difficult to control the exact meniscus 53 position at all points of contact at the wall 54, with the result that tilts can develop, thereby inducing aberrations into the lens performance. In order to utilize the advantages of the specially shaped wall section 54, while gaining better control on meniscus position, a series of steps are introduced into the chamber 50 designs in the region where the meniscus contacts the chamber 50 walls (over the region of special shaping 54). Some of the wall section steps are labeled 55, 56 and 57 in order to illustrate the principle behind the invention, but as detailed in FIG. 5 the number of wall section steps is not limited to the labeled regions.

At the starting position considered here, one part of the meniscus 53 is in contact with a first wall section 55 at its top point. As a gradient magnetic field is applied to the chamber 50, the meniscus 53 is forced to move due to local volume changes in the second fluid 52. In this case the fluid 52 at the first wall section 55 will move downwards along the wall section 55. Eventually it will contact the junction between first wall section 55 and second wall section 56. A preferred location for the meniscus 53 in this region of the junction may additionally be ensured by extra shaping of the wall sections 55 and 56 or by locally preparing the surface with a special coating. The wall sections 55, 56 and 57 are illustrated in the diagram as a series of flat regions, but these could take the form of wedges, mini-spheres, or other shapes capable of forming localized pockets of low energy states for the meniscus 53. With a preferred location between first wall section 55 and second wall section 56, a change in magnetic field applied to the chamber moves the meniscus 53 not continuously along the wall but discontinuously between two preferred locations. A third preferred location for the meniscus 53 can be added with the introduction of a third wall section 57, designed with an optimum meniscus position as a guideline, and reached by further increase of the applied magnetic field. In this example the energy of the fluid system is almost or completely independent of lens curvature at all the six equilibrium positions: only in between the equilibrium positions the energy is (here slightly) higher, which helps to stabilize each of the six possible meniscus curvatures when the field is switched. (The number of equilibrium positions is variable depending on system design). Thus the energy and power advantages, and the advantages of increased lens area and improved lens shape, permitted by the overall wall section 54, are maintained (or even improved by switching off the field as soon as a new equilibrium position is reached). Within the continuum of positions more preferred positions could be defined, still with good lens characteristics, by using smaller wall section regions 55, 56 and 57 for example, for more precise control of meniscus position and tilt.

### List of Reference Numerals

1. chamber
2. first fluid
3. magnetic field susceptible second fluid
4. meniscus
5. contact angle
6. electrically conducting coil
7. voltage supply V
8. lightbeam
9. focus point
20. lens chamber
21. cylindrical wall section
22. cylindrical wall section
23. first fluid
24. magnetic field susceptible second fluid
25. meniscus
26. contact angle
27. wall section
28. wall section
W width of effective lens
30. device chamber
31. first fluid
32. magnetic field susceptible second fluid
33. meniscus
34. internal wall section
35. internal wall section
36. contact angle
37. light source
40. chamber
41. independent electrically conducting coil
42. independent electrically conducting coil
43. meniscus at starting position
44. contact angle
45. curved container wall
46. arrow indicating movement of fluid due to magnetic field produced by current in coil 41
47. meniscus curvature following activation of coil 41
48. arrow indicating movement of fluid due to magnetic field produced by current in coil 42
49 meniscus curvature following activation of coil 42
50. lens chamber
51. first fluid
52. magnetic field susceptible second fluid
53. meniscus
54. shaped wall section
55. first wall section
56. second wall section
57. third wall section

1. A variable focus lens comprising,
a fluid chamber containing a first fluid and a second fluid, the fluids being immiscible and in contact over a meniscus, and the second fluid being able to alter its shape under the influence of a magnetic field,
also comprising means for applying a gradient magnetic field over at least part of the fluid chamber,
the shape of the meniscus comprising a curvature under application of the gradient magnetic field, which is distorted by a physical requirement of a constant contact angle where the meniscus contacts a chamber wall, such that the curvature comprises a first region of high distortion close to the chamber wall and a second region of low distortion away from the chamber wall,
characterized in that,
the curvature is arranged by a compensating wall section such that in the first region of high distortion the curvature approaches an extrapolation of the curvature in the second region of low distortion.

2. A variable focus lens as claimed in claim 1 where the wall section is sub-divided into discreet regions of variable local shape superimposed on the shape of the wall section.

3. A variable focus lens as claimed in claim 1 wherein the second fluid comprises a Ferro fluid.

4. A variable focus lens as claimed in claim 1 where the means for applying a gradient magnetic field comprises at least two independent electrically conducting coils.

5. A solid-state lighting device comprising a variable focus lens as claimed in claim 1.

6. An optical device comprising a variable focus lens as claimed in claim 1.

7. An image capture device comprising a variable focus lens as claimed in claim 1.

8. An optical recording device comprising a variable focus lens as claimed in claim 1.

9. A telephone comprising a variable focus lens as claimed in claim 1.
